(19) United States
(12) Patent Application Publication
(10) Pub. No.: US 2007/0014957 A1
(43) Pub. Date: Jan. 18, 2007

(54) Patch for boards

(76) Inventors: Dean Sislin, Santa Ana, CA (US); Kenneth Luna, Santa Ana, CA (US)

Correspondence Address: Maria Erlinda C. Sarno, Esq., P.O. Box 1023, Artesia, CA, 90702, US

(21) Appl. No.: 11/182,584

(22) Filed: Jul. 16, 2005

(51) Int. Cl. B32B 33/00

(52) U.S. Cl. 428/40.1; 428/157; 428/172

(57) ABSTRACT

A patch for boards used in sports, comprising a flexible, stretchable and water impervious top layer having a central flat portion and an extension for providing a grip, the extension tapering in thickness from a thickness of the central flat portion of the patch; a waterproof pressure sensitive adhesive applied on one side of the top layer; and, a releasable liner attached to the pressure sensitive adhesive in a releasable manner.

This invention relates to a patch particularly useful for boards used in sports especially those exposed to the natural elements like water and snow.

### BACKGROUND

There are a variety of sports that use boards such as surfing, snowboarding and the like. In these type of sports, a person usually rides on top of the board. Occasionally, there may be more than one person. These boards are always exposed to objects that could damage the board such as unforseen rocks, foreign matters, trees, bumps, etc. or in some occasions, persons bumping their boards with each other. Boards can also be damaged even on storage. A person usually brings or owns only one board because of so many factors like cost, bulkiness, weight, change of styles, need to change sizes, etc. At the present time, damages to the boards are usually repaired by tapes such as duct tapes which not only would eventually come off because of inadequate adhesion but it is also cosmetically unacceptable. A patch for surfboard currently in the market comes only in one size, are rectangular in shape and are not flexible and stretchable. It would be difficult to apply these patches smoothly on surfaces that are not flat without forming folds, creases or channels between the patch and the board. Additionally, an abrupt change in the contour of the surface of the board caused by the thickness of the patch will cause some drag with the elements to which a board is subjected to such as water and snow. These patches also do not have superior adhesion necessary for the patch to withstand the forces that constantly impact the board during usage such as a strong gush of water or waves and heavy snow.

It is therefore an object of this invention to provide a patch that can repair a board in a short period of time.

It is also an object of this invention to provide a portable patch that can be carried by a person anywhere ready for use if needed.

It is a further object of this invention to provide a patch that can not be torn or peeled off by the natural forces of water and snow.

It is also a further object of this invention to provide a patch that can be pre-installed at the peripheral edges of the board where damage mostly occur with usage.

### SUMMARY

This invention relates to a patch for boards used in sports, comprising a flexible, stretchable and water impervious top layer having a central flat portion of a given thickness and an extension for providing a grip. The extension taper in thickness from the thickness of the central flat portion of the patch to a minimum thickness physically attainable by injection molding. A pressure sensitive adhesive is applied on one side of the top layer and a releasable liner is attached to the pressure sensitive adhesive in a releasable manner. The extension come in pairs at a location opposite each side of the central flat portion for balance. The extension can come in different shapes so long as the edges are rounded, that is, no corners and no pointed tips. One type of extension is a clasping strip tapering in thickness at each side of the central flat portion of the patch for covering the edges of a board. The clasping strip include a slit having rounded edges for each turn in direction on a peripheral edge of the board. Other extensions used to cover or patch damages or dents on the board are finger like or are protrusions with rounded edges, that is, no tips and no corners. These finger like extensions and protrusions with rounded edges are hereinafter collectively referred to as finger like extension. An example of achieving this is to have an intermediary edge between the finger like extensions. Like the extensions, the intermediary edge taper in thickness from the thickness of the central flat portion of the patch to a minimum thickness physically attainable by injection molding. The central flat portion of the top layer can have different geometric shape and different dimensions. The top layer can have different colors and imprints of different designs and lettering. The thickness of the central flat portion for a given patch can vary depending upon the severity and type of damage on the board. To withstand exposure to water and snow, the adhesive is waterproof, not losing its bonding even after being soaked in water and has a short setting time to facilitate repair thereby prevent further worsening of the damage.

Other embodiments of the present invention will become readily apparent to those skilled in the art from the following detailed description, wherein it shows and describes only certain embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Aspects of the present invention are illustrated by way of example, and not by way of limitation, in the accompanying drawings, wherein:

FIG. 1 shows the components of the patch.

FIG. 2A-2D are front views of some of the repair patches.

FIG. 2E is a front view of a patch having only one pair of extension.

FIG. 3 shows examples of damage on a board.

FIG. 3A shows the application of a patch on the damages shown in FIG. 3.

FIG. 4 is a side view of the patch after it is applied on a board.

FIG. 5 shows how the extension in breath for the finger like extensions are calculated.

FIG. 6 shows a surfboard protected around the edges with the patch.

FIG. 6A is a blow up of the slit on the clasping strip of the patch.

### DETAILED DESCRIPTION OF THE INVENTION

The detailed description represented herein is not intended to represent the only way or the only embodiment in which the claimed invention may be practiced. The description herein is provided merely as an example or examples or illustrations of the claimed invention and should not be construed as the only way or as preferred or advantageous over other embodiments or means of practicing the invention. Any stretchable, flexible and water impervious patch for repairing damages on a sporting board having extensions for better grip is within the scope of this invention. The detailed description includes specific details to provide a thorough understanding of the claimed invention and it is apparent to those skilled in the art that the claimed invention may be practiced without these specific details. In some instances, well known structures and devices are shown in block diagrams in order to either avoid obscuring the main concepts of the invention or to show the relationship of one part to the other.

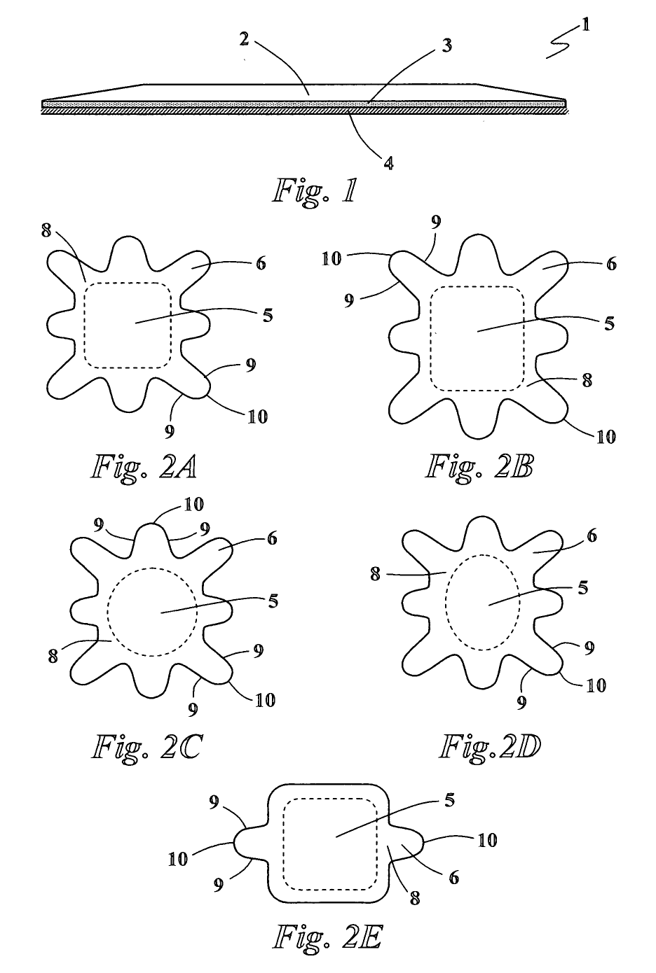

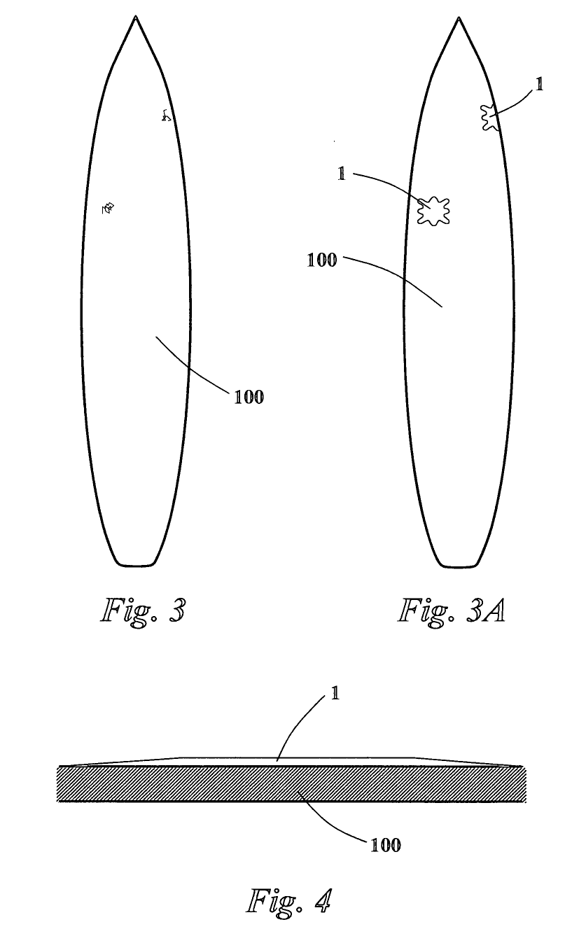

The patch herein could repair a damage on a board in a short period of time. A short period of time means less than five minutes. These patches are designed to last for a time and are not temporary fixes. As used herein, repair patches are the patches used for repairing damages on a board while maintenance patches are those pre-installed to a new board to prevent future damages. Both of these patches, although identified differently by function, are the same in construction. The patch 1 in its simplest form includes a top layer 2, a pressure sensitive adhesive 3 applied on one side of the top layer 2, and a release film or liner 4 attached in a releasable manner to the adhesive layer 3. FIG. 1 shows the layering of these components. The top layer 2 has a central flat portion 5 and finger like extensions 6. The central flat portion of the top layer can have different geometric shape. FIGS. 2A-2D show the front view of some of the proposed repair patches. These finger like extensions provide the grip and bonding for the repair patch and are recommended to come in pairs for balance to achieve optimum bonding with the board. Balance means that the extensions come in pairs and are in locations directly opposite each other. Here, they are on opposite sides of the central flat portion. The minimum is one pair as shown in FIG. 2E but there can be more than one pair. The maximum number of finger like extensions 6 in a patch highly depend upon the strength of bonding desired and the number of extensions that can be accommodated by the dimensions of the central portion 5. FIG. 3 show examples of how and where a board is usually damaged and FIG. 3A show how the patch is applied to the damages shown in FIG. 3. The finger like extensions can be shaped differently from that shown in FIGS. 2A-2D so long as the protrusions have rounded edges, that is no corners, tips or sharp turned edges. As stated above, these extensions are collectively referred to herein as finger like extensions. The top layer 2 can come in different colors and design. Drawings and letters can be imprinted on the side of the top layer opposite the adhesive. Although not intended for, a person may also use these patches for decorative and advertising purposes.

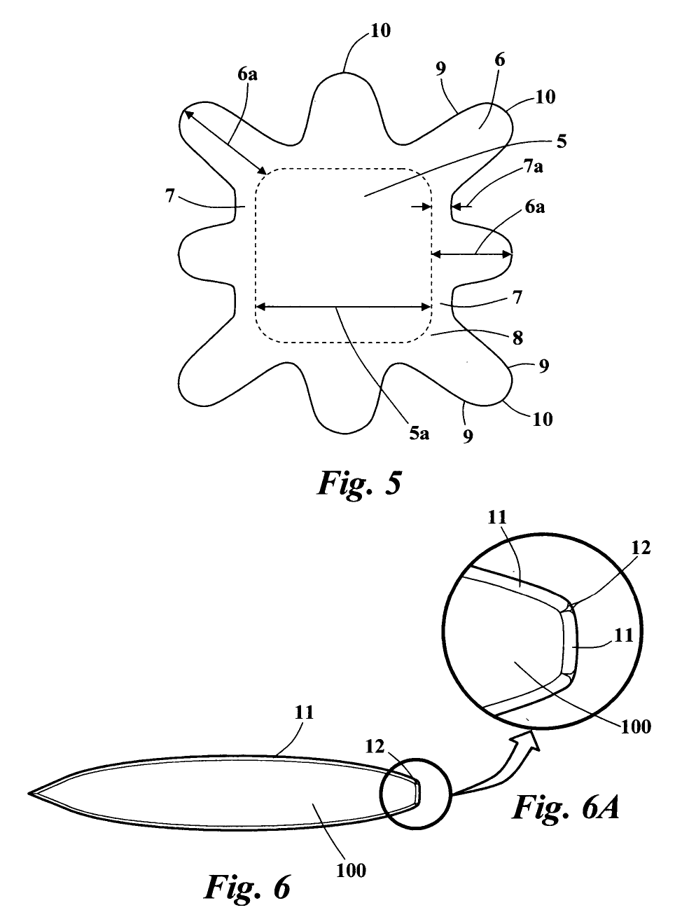

To withstand damage and have the least amount of drag, for example, by water on a surfboard or by snow on a snowboard, the characteristics and thickness of the patch is recommended to be at a certain range. The central portion 5, bordered herein in broken lines to show the coverage, is flat. The thickness of the central flat portion for a given patch can vary depending upon the severity and type of damage on the board. The thickness can range from 8-40 mil depending upon the size of the patch, with the larger patch having a thicker central top portion. This is sufficient to provide the strength but at the same time insufficient to cause a bump on the surface of the board after attachment. Because the patch is stretchable, any severe dent will be covered by the patch. It does not matter whether there is a small void formed between the dent and the patch because the stretching and superior bonding of the finger like extensions to the board will keep the outside surface covering the damage/dent flat. The patch can have, immediately surrounding the flat central portion 5 and not extending to the finger like extensions, an intermediary edge 7 which ranges in thickness from the thickness of the central flat portion 5 to the minimum thickness achievable by the mold where the material for the top layer is injection molded. These intermediary edges 7 prevent having sharp corners between the finger like extensions. The finger like extensions 6 protruding from the central portion 5 also have a tapering thickness. The area 8 proximate to the central portion 5 is at the same thickness as the central portion but this tapers gradually in such a manner that the edges 9 around the tips 10 of the finger like extensions are at the minimum thickness physically achievable by the mold, as the intermediary edge 7. This is usually approximately 1 mil in thickness. An intermediary edge of at least one tenth ( 1/10) of the length of the central flat portion from which it extends from, shown in FIG. 5 as 7a, is sufficient. FIG. 4 shows a side view of the patch after application on a board 100. Once the patch is stretched and applied over the damaged portion, the thickness of the resulting edges can be even less than the minimum thickness achievable by the mold. The increase in thickness caused by the patch on the board will be minimal as felt by running a finger across the patched area. This is important to avoid or minimize any dragging effect caused by the patch and to prevent the patch from scratching the skin due to continued contact. The tapering of the thickness from the central flat portion to the edges decreases any drag that can be caused by an abrupt change in surface elevation due to the thickness of a patch. Maintaining a smooth surface is important to maintain the performance of the damaged board.

The dimensions of the central portion 5 may vary according to the shape and area/dimensions of the damage to be repaired. These patches can be made commercially available in different dimensions and shapes to cater to one's needs. Each finger like extension 6a is usually from one-third to one-half (⅓ to ½) of the length or breath 5a of the central flat portion from which it is extending from. For example, the total length added by a pair of finger like extensions to the central flat portion will be a total of two-thirds of to one time (⅔ to 1×) the length of the central flat portion 5 as shown in FIG. 5.

The finger like extensions allow the patch to cling to a non-flat surface and reinforce the bonding between the central flat portion 5 and the board as shown in FIG. 3A. The finger like extension aids in conforming the patch with the shape of the surface of the board on which it would be applied. It is important that the patch smoothly covers the damage area without any resulting fold, crease, bump or channel, hereinafter collectively called fold. A fold will not only cause a drag but it can also initiate the entry of water into the interior area covered by the patch. Wetting of the materials at the interior of the board will weaken the material in time and can cause molds to form inside the board.

The top layer 2 should be made of a strong flexible, stretchable and water impervious material to avoid the formation of folds during the adhesion of the patch into the board and prevent entry of water into the interior. Plastic, latex, rubber and synthetic rubber are examples of materials that can be used. Flexible, stretchable and waterproof plastic materials are usually formulated or derived from polyvinyl chloride, polyethylene, polypropylene, polystyrene and, polyurethane. Use of plastic material gives better control on the return rates or spring back characteristic (also referred to as memory) compared to the use of rubber, latex and synthetic rubber. It is also important to use a plastic material that does not curl once the release liner is removed to be able to easily adhere the patch at the desired predetermined position.

Aside from the desired characteristics of the top layer, it is also important that the adhesive applied to the top layer possess superior bonding to keep the patch in place for a period of time. A proper adhesive will keep the patch attached to the board until physically removed. Since the boards are exposed to water and snow, the adhesive should be also be waterproof as the top layer and should not lose its bonding even when soaked in water. Further, it is desirable to have an adhesive that has a short setting time, that is, it adheres and bond the patch to the board in less than five minutes. An example of a suitable adhesive is a high strength acrylic adhesive such as Adhesive 300LSE sold by 3M, 3M Center, Building 551-1W-02, St. Paul, Minn. 55144-1000. This type of adhesive has an application temperature range of 700 to 100° F. The thickness of the pressure sensitive adhesive is recommended to be approximately 1-2 mil. Typical release liners such as kraft, aluminum, glassine paper, paper substrate coated with release agents such as silicone, etc. can be used here.

The top layer 2 of the patch is manufactured by injection molding according to the thickness requirements stated above. The pressure sensitive adhesive 3 is applied to one side of the top layer, the side that would adhere to the board. There are so many known means of applying adhesive to a matrix such as automatically or manually coating the adhesive to the top layer. The adhesive can also be co-extruded with the top layer. Other processes have compounded the top layer and the adhesive together and co-extruded these with the release liner. The Adhesive 300LSE sold by 3M has the adhesive sandwiched between two release liners. With this, one release liner is removed when the adhesive is applied to the top layer and the other release liner is removed when the patch is applied to the board.

The same patch, as stated above, can be applied to a board as a preventive rather than a curative measure. The only difference between the repair patch as described above and the maintenance patch as referred to herein would be the shape of the extension. For example, to protect the edges of the board where most damage occurs, the patch should be a rectangular strip long enough to cover the peripheral edges of the board and wide enough to wrap around the edges as shown in FIG. 6. As in the repair patch, there would be a central flat portion that is rectangular in shape to wrap around the flat edges of the board and instead of a finger like extension, the central flat portion will have a pair of clasping strip 11 tapering in thickness at opposite sides or ends of the central flat portion. The extension, herein referred to as clasping strip 11, would have a slit 12 usually triangular in shape with rounded edges to accommodate a change in the contour or direction also referred to as turn on the peripheral edge of the board as shown in FIG. 6A. The number of slits will vary depending upon the number of turns along the peripheral edges of the board. These slits prevent the formation of folds along the edges. The slit can deviate from a triangular shape as long as the other shaped slits have rounded edges.

While the embodiments of the present invention have been described, it should be understood that various changes, adaptations, and modifications may be made therein without departing from the spirit of the invention and the scope of the claims.

We claim:

1. A patch for boards used in sports, comprising:
a flexible, stretchable and water impervious top layer having a central flat portion and an extension for providing a grip, the extension tapering in thickness from a thickness of the central flat portion of the patch;
a pressure sensitive adhesive applied on one side of the top layer; and,
a releasable liner attached to the pressure sensitive adhesive in a releasable manner.

2. The patch of claim 1 wherein the extension come in pairs at a location opposite each side of the central flat portion for balance.

3. The patch of claim 1 wherein the extension is a clasping strip tapering in thickness at each side of the central flat portion of the patch.

4. The patch of claim 3 wherein the clasping strip include a slit having rounded edges for each turn on a peripheral edge of the board.

5. The patch of claim 1 wherein the extension is finger like.

6. The patch of claim 1 wherein the extension is a protrusion with rounded edges.

7. The patch of claim 1 wherein the patch has an intermediary edge between each extension, the intermediary edge tapering in thickness from the thickness of the central flat portion of the patch to a minimum thickness physically attainable by injection molding.

8. The patch of claim 1 wherein each extension has a length of one third to one half of a length of the central flat portion of the top layer from which the extension is extending from.

9. The patch of claim 1 wherein each extension is tapering in thickness from the thickness of the central flat portion of the patch to a minimum thickness physically attainable by injection molding.

10. The patch of claim 1 wherein the central flat portion of the top layer is of different geometric shape.

11. The patch of claim 1 wherein the central flat portion of the top layer is of different dimensions.

12. The patch of claim 1 wherein the top layer is of different colors.

13. The patch of claim 1 wherein the top layer can have an imprint of different designs and lettering.

14. The patch of claim 1 wherein the central flat portion of the top layer is approximately 8-40 mil in thickness.

15. The patch of claim 1 wherein the adhesive is waterproof, not losing its bonding even after being soaked in water.

16. The patch of claim 1 wherein the adhesive has a short setting time.

17. The patch of claim 1 wherein the patch is used for decorative and advertising purposes.

18. A patch for repairing damages on boards used in sports, comprising:
a flexible, stretchable and water impervious top layer having a central flat portion and an extension for providing a grip, the extension tapering in thickness from a thickness of the central flat portion of the patch, the thickness of the central flat portion dependent upon the severity of the damage and size of the patch;
a waterproof pressure sensitive adhesive applied on one side of the top layer; and,
a releasable liner attached to the pressure sensitive adhesive in a releasable manner.
